(19) United States
(12) Patent Application Publication
(10) Pub. No.: US 2026/0036891 A1
(43) Pub. Date: Feb. 5, 2026

(54) LIGHT SOURCE APPARATUS AND PROJECTOR

(71) Applicant: SEIKO EPSON CORPORATION, Tokyo (JP)

(72) Inventors: Namiko ONOTA, MATSUMOTO-SHI (JP); Wataru YASUMATSU, AZUMINO-SHI (JP)

(21) Appl. No.: 19/286,389

(22) Filed: Jul. 31, 2025

(30) Foreign Application Priority Data
Aug. 2, 2024 (JP) 2024-127669

(51) Int. Cl. G03B 21/20

(52) U.S. Cl. CPC G03B 21/204; G03B 21/2066; G03B 21/208

(57) ABSTRACT

A light source apparatus includes a light source configured to output first light; a first optical system that the first light output from the light source enters; a light collection system that the first light passing through the first optical system enters; and a wavelength converter configured to convert part of the first light into second light, the wavelength converter having a light exiting surface on which the first light is incident and through which the second light exits, and a first reflection film configured to separate the first light into the part and the other part, the first optical system includes a first optical element that includes a second reflection film configured to reflect the other part of the first light, and a diffusion layer configured to diffusively transmit the first light, and a second optical element configured to transmit the first light and reflect the second light.

The present application is based on, and claims priority from JP Application Serial Number 2024-127669, filed Aug. 2, 2024, the disclosure of which is hereby incorporated by reference herein in its entirety.

### BACKGROUND

### 1. Technical Field

The present disclosure relates to a light source apparatus and a projector.

### 2. Related Art

In related art, there is a proposed light source apparatus that separates blue light output from a light source into two parts, causes one of the parts, into which the blue light is separated, to enter a phosphor to generate yellow fluorescence, and diffuses the other part of the separated parts, into which the blue light is separated, combines the diffused blue light with the yellow fluorescence to produce white light, and outputs the white light (see JP-A-2018-013764, for example).

JP-A-2018-013764 is an example of the related art.

In the light source apparatus described above, however, since the optical path of the part of the blue light traveling toward the phosphor and the optical path of the other part of the blue light traveling toward the diffuser plate differ from each other, it is necessary to dispose optical parts in the optical paths, so that there is a problem of an increase in size of the apparatus configuration.

### SUMMARY

According to a first aspect of the present disclosure, there is provided a light source apparatus including: a light source configured to output first light having a first wavelength band; a first optical system that the first light output from the light source enters; a light collection system that the first light passing through the first optical system enters; and a wavelength converter configured to convert part of the first light into second light having a second wavelength band different from the first wavelength band, wherein the wavelength converter includes a wavelength conversion layer having a light exiting surface on which the first light is incident and through which the second light exits, and a first reflection film provided at the light exiting surface and configured to separate the first light into the part of the first light and the other part of the first light, the first optical system includes a first optical element and a second optical element, the first optical element includes a second reflection film configured to reflect the other part of the first light, and a diffusion layer configured to diffusively transmit the first light, and the second optical element includes a third reflection film configured to transmit the first light and reflect the second light.

According to a second aspect of the present disclosure, there is provided a projector including the light source apparatus according to the first aspect, a light modulator configured to modulate light incident from the light source apparatus in accordance with image information, and a projection optical apparatus configured to project the light modulated by the light modulator.

### BRIEF DESCRIPTION OF THE DRAWINGS

FIG. 1 is a schematic view showing the configuration of a projector according to a first embodiment.

FIG. 2 is a schematic view showing the configuration of a light source apparatus.

FIG. 3 is a schematic view showing the configuration of a light source apparatus according to a modification.

FIG. 4 is a schematic view showing the configuration of a light source apparatus according to a second embodiment.

FIG. 5 shows the configuration of a modification of a wavelength converter in the second embodiment.

### DESCRIPTION OF EMBODIMENTS

Embodiments of the present disclosure will be described below with reference to the drawings. In the drawings, elements are drawn at dimensional scales changed from the actual ones in some cases for clarity of each of the elements.

### First Embodiment

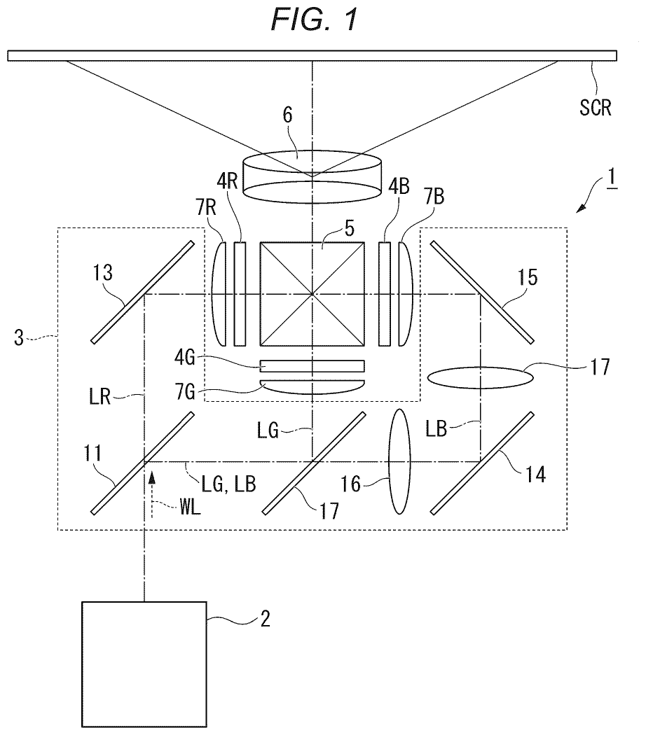

A projector according to a first embodiment of the present disclosure will first be described with reference to FIG. 1. FIG. 1 is a schematic view showing the configuration of a projector 1 according to the first embodiment.

The projector 1 is a projection-type image display apparatus that displays a video on a screen SCR, as shown in FIG. 1. The projector 1 includes a light source apparatus 2, a color separation system 3, light modulators 4R, 4G, and 4B, a light combining system 5, and a projection optical apparatus 6. The projector 1 is a three-panel projector including three light modulators.

The light source apparatus 2 outputs white illumination light WL toward the color separation system 3. The illumination light WL is illumination light in the projector 1, and contains red light LR, green light LG, and blue light LB. The configuration of the light source apparatus 2 will be described later.

The color separation system 3 separates the illumination light WL into the red light LR, the green light LG, and the blue light LB. The color separation system 3 includes, for example, a first dichroic mirror 11, a second dichroic mirror 12, a first reflection mirror 13, a second reflection mirror 14, a third reflection mirror 15, a first relay lens 16, and a second relay lens 17.

The first dichroic mirror 11 is disposed in the optical path of the illumination light WL output from the light source apparatus 2, and separates the incident illumination light WL into the red light LR, and the mixture of the green light LG and the blue light LB. The first dichroic mirror 11 transmits the red light LR and reflects the green light LG and the blue light LB. The second dichroic mirror 12 is disposed in the optical path common to the green light LG and the blue light LB output from the first dichroic mirror 11, and separates the green light LG and the blue light LB from each other. The second dichroic mirror 12 transmits the blue light LB and reflects the green light LG.

The first reflection mirror 13 reflects the red light LR toward the light modulator 4R. The second reflection mirror 14 and the third reflection mirror 15 guide the blue light LB to the light modulator 4B. The green light LG is reflected by the second dichroic mirror 12 toward the light modulator 4G. The red light LR, the green light LG, and the blue light LB contained in the illumination light WL correspond to the light output from the light source apparatus 2.

The first relay lens 16 is disposed in the optical path of the blue light LB between the second dichroic mirror 12 and the second reflection mirror 14. The second relay lens 17 is disposed in the optical path of the blue light LB between the second reflection mirror 14 and the third reflection mirror 15. The aforementioned arrangement of the first relay lens 16 and the second relay lens 17 compensates for optical loss of the blue light LB. The optical loss of the blue light LB is caused by the fact that the optical path length of the blue light LB from the first dichroic mirror 11 to the light modulator 4B is longer than the optical path length of the red light LR from the first dichroic mirror 11 to the light modulator 4R and the optical path length of the green light LG from the first dichroic mirror 11 to the light modulator 4G.

The light modulator 4R is disposed in the optical path of the red light LR reflected by the first reflection mirror 13 and output from the first reflection mirror 13. The light modulator 4R modulates the red light LR incident thereon in accordance with image information input from an image input apparatus that is not shown to form red image light and to output the red image light. The light modulator 4G is disposed in the optical path of the green light LG reflected by the second dichroic mirror 12 and output from the second dichroic mirror 12. The light modulator 4G modulates the green light LG incident thereon in accordance with image information input from the image input apparatus, which is not shown, to form green image light and outputs the green image light. The light modulator 4B is disposed in the optical path of the blue light LB reflected by the third reflection mirror 15 and output from the third reflection mirror 15. The light modulator 4B modulates the blue light LB incident thereon in accordance with image information input from the image input apparatus, which is not shown, to form blue image light and outputs the blue image light. The image input apparatus is, for example, a personal computer or a portable terminal device.

The light modulators 4R, 4G, and 4B are, for example, a transmissive liquid crystal panel, respectively. Polarizers that are not shown are disposed at the light incident and exiting sides of each of the liquid crystal panels. A field lens 7R is disposed in the optical path of the red light LR between the first reflection mirror 13 and the light modulator 4R. A field lens 7G is disposed in the optical path of the green light LG between the second dichroic mirror 12 and the light modulator 4G. A field lens 7B is disposed in the optical path of the blue light LB between the third reflection mirror 15 and the light modulator 4B.

The light combining system 5 is disposed so as to lie on the optical path of the red image light output from the light modulator 4R, the optical path of the green image light output from the light modulator 4G, and the optical path of the blue image light output from the light modulator 4B. In the plan view as shown in FIG. 1 or a side view, the position where the light combining system 5 combines the three types of color light with each other coincides with the intersection of the optical path of the red image light, the optical path of the green image light, and the optical path of the blue image light. The light combining system 5 combines the red image light, the green image light, and the blue image light with each other to form color image light. The light combining system 5 outputs the color image light. The light combining system 5 is, for example, a cross dichroic prism.

The projection optical apparatus 6 is disposed in the optical path of the color image light output from the light combining system 5. The color image light output from the light combining system 5 corresponds to the light modulated by the light modulators 4R, 4G, and 4B. The projection optical apparatus 6 enlarges the color image light output from the light combining system 5 and entering the projection optical apparatus 6, and projects the enlarged color image light toward the screen SCR. The color image light enlarged and projected by the projection optical apparatus 6 is displayed as a color video on a display surface of the screen SCR that is a surface facing a light exiting surface of the projection optical apparatus 6.

The projection optical apparatus 6 is configured, for example, with multiple optical lenses, and may instead be configured with a single optical lens. Examples of the optical lenses may include a variety of lenses, such as a planoconvex lens, a biconvex lens, a meniscus lens, an aspherical lens, a rod lens, and a freeform surface lens.

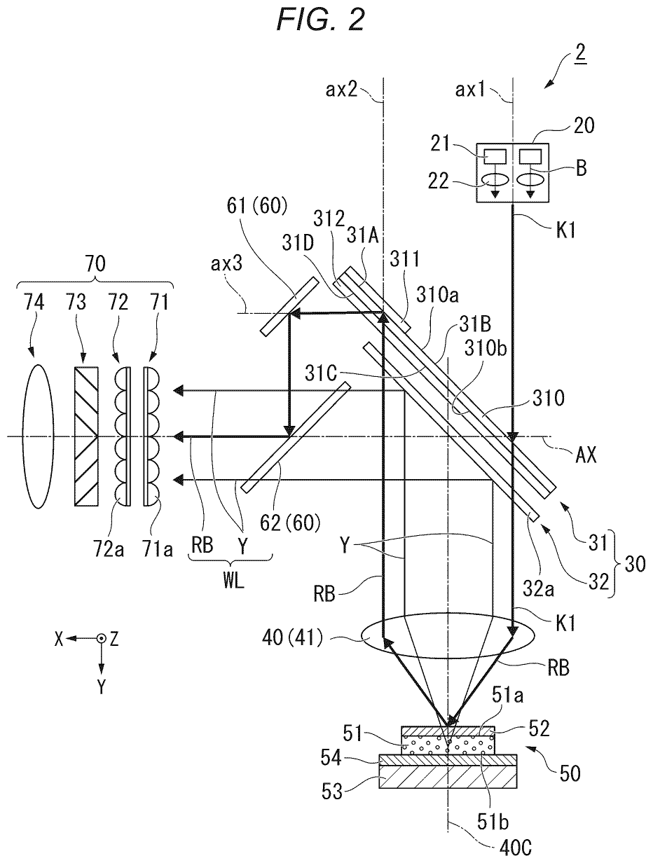

The light source apparatus 2 according to an embodiment of the present disclosure will subsequently be described. FIG. 2 is a schematic view showing the configuration of the light source apparatus 2 according to the present embodiment.

In the following drawings including FIG. 2, each element of the light source apparatus 2 will be described by using an XYZ coordinate system as necessary. The X-axis is an axis parallel to an illumination optical axis AX of the light source apparatus 2, the Y-axis is an axis parallel to optical axes ax1 and ax2 of the light source apparatus 2, and the Z-axis is an axis orthogonal to the X-axis and the Y-axis. That is, the optical axes ax1 and ax2 and the illumination optical axis AX are in the same plane, and the optical axes ax1 and ax2 are orthogonal to the illumination optical axis AX.

The light source apparatus 2 includes a light source 20, a first optical system 30, a light collection system 40, a wavelength converter 50, an optical path adjustment system 60, and a uniform illumination system 70, as shown in FIG. 2.

In the light source apparatus 2 according to the present embodiment, the light source 20, the first optical system 30, the light collection system 40, and the wavelength converter 50 are arranged along the optical axis ax1, which is the optical path of the chief ray of blue light K1 output from the light source 20. The wavelength converter 50, the light collection system 40, and the first optical system 30 are arranged along the optical axis ax2, which is the optical path of the chief ray of blue reflected light RB, which is output from the wavelength converter 50 as will be described later. The first optical system 30 and the optical path adjustment system 60 are disposed in the X-axis direction along the illumination optical axis AX.

The light source 20 includes multiple light emitters 21 and multiple collimation lenses 22. The multiple light emitters 21 are each configured with a semiconductor laser. The multiple light emitters 21 are arranged in an array in an XZ plane perpendicular to the optical axis ax1. The light emitters 21 each emit a blue beam B configured with a light beam having a peak wavelength of, for example, 445 nm. Note that the light emitters 21 can instead each be a semiconductor laser that emits a beam B having a wavelength other than 445 nm (460 nm, for example).

The multiple collimation lenses 22 are arranged, for example, in an array. The multiple collimation lenses 22 are disposed in correspondence with the multiple light emitters 21, respectively. The collimation lenses 22 each convert the beam B emitted from the corresponding light emitter 21 into parallelized light.

The light source 20 thus outputs the blue light K1 in the form of a parallelized luminous flux having a blue wavelength band (first wavelength band) and containing the multiple beams B.

The blue light K1 output from the light source 20 enters the first optical system 30. The configuration of the first optical system 30 will be described later in detail.

The blue light K1 passes through the first optical system 30 and enters the light collection system 40. The light collection system 40 includes at least one lens 41 having positive power. The lens 41 having positive power is configured, for example, with a convex lens or a planoconvex lens.

The light collection system 40 has the function of directing the blue light K1 in such a way that the blue light K1 is collected at the wavelength converter 50 and the function of picking up and parallelizing the light output from the wavelength converter 50.

The optical axis ax1 of the blue light K1 passing through the first optical system 30 and entering the light collection system 40 is shifted from a center axis 40C of the light collection system 40. Note that the center axis 40C of the light collection system 40 is an axis passing through the center of the lens 41, and when the light collection system 40 is configured with multiple lenses, the center axis 40C is an axis passing through the center of each of the multiple lenses.

In the present embodiment, the optical axis ax1 of the blue light K1 is shifted from the center axis 40C of the light collection system 40 toward the +X side in the XY plane.

The blue light K1 is therefore obliquely incident on the center of the wavelength converter 50 in the XY plane. In the present embodiment, it is preferable that the blue light K1 does not coincide with the center axis 40C of the light collection system 40 but enters only a region of the light collection system 40 that is a region shifted from the center axis 40C toward the −X side. A reflected component of the blue light K1 that is reflected by the wavelength converter 50 can thus be efficiently extracted from a region shifted from the center axis 40C toward the +X side, so that the reflected component of the blue light K1 can efficiently enter the light collection system 40.

The wavelength converter 50 converts part of the blue light K1 into fluorescence Y.

The wavelength converter 50 includes a wavelength conversion layer 51, a light separation film 52, a substrate 53, and a reflection member 54. The blue light K1 in the present embodiment corresponds to an example of the “first light” in the present disclosure, the fluorescence Y in the present embodiment corresponds to an example of the “second light” in the present disclosure, and the light separation film 52 in the present embodiment corresponds to an example of the “first reflection film” in the present disclosure.

The wavelength conversion layer 51 contains a ceramic phosphor that converts the blue light K1 having the first wavelength band into the fluorescence Y having a second wavelength band different from the first wavelength band. The second wavelength band ranges, for example, from 490 to 750 nm, and the fluorescence Y is yellow light containing a green light component and a light red light component. Note that the phosphor may contain a single crystal phosphor.

The substrate 53 functions as a support substrate that supports the reflection member 54 and the wavelength conversion layer 51, and also functions as a heat dissipation substrate that dissipates heat generated in the wavelength conversion layer 51. The substrate 53 is made of a material having high thermal conductivity, for example, metal or ceramic. The substrate 53 may include, for example, a heat dissipation member such as a heat sink at the surface opposite the surface that supports the wavelength conversion layer 51.

The reflection member 54 is provided between the substrate 53 and the wavelength conversion layer 51, and reflects the fluorescence Y incident from the wavelength conversion layer 51 toward the wavelength conversion layer 51. The reflection member 54 is configured, for example, with a stacked film including a dielectric multilayer film, a metal mirror, a reflection enhancing film, and the like.

The wavelength conversion layer 51 has a light exiting surface 51a, on which the blue light K1 is incident and through which the fluorescence Y exits, and a rear surface 51b facing the substrate 53.

The wavelength conversion layer 51 contains, for example, an yttrium-aluminum-garnet-based (YAG-based) phosphor. Consider YAG: Ce, which contains cerium (Ce) as an activator, by way of example, and the phosphor can be made, for example, of a material produced by mixing raw powder materials containing Y₂O₃, Al₂O₃, CeO₃, and other constituent elements with one another and causing the mixture to undergo a solid-phase reaction; Y—Al—O amorphous particles produced by using a coprecipitation method, a sol-gel method, or any other wet method; or YAG particles produced by using a spray-drying method, a flame-based thermal decomposition method, a thermal plasma method, or any other gas-phase method.

The light separation film 52 is provided at the light exiting surface 51a of the wavelength conversion layer 51. The light exiting surface 51a of the wavelength conversion layer 51 is substantially planar, and the light separation film 52 is also configured with a planar film.

The light separation film 52 is configured with a dielectric multilayer film having an optical characteristic of transmitting the fluorescence Y and part of the blue light K1 and reflecting the other part of the blue light K1. In the present embodiment, when the transmittance of the light separation film 52 for the blue light K1 is set, for example, at 20%, the light separation film 52 transmits part (20%) of the blue light K1 and reflects the other part (80%) of the blue light K1 to separate the blue light K1 into the part and the other part.

The part of the blue light K1, which has passed through the light separation film 52, enters the wavelength conversion layer 51 as excitation light and is converted into the fluorescence Y. The fluorescence Y passes through the light separation film 52 provided at the light exiting surface 51a of the wavelength conversion layer 51 and exits out of the wavelength converter 50. The fluorescence Y exits omnidirectionally over a wide radiation angle substantially around the Y-axis direction in the form of Lambertian light emission. The light collection system 40 in the present embodiment is so disposed that the light emission center of the fluorescence Y coincides with the center axis 40C. The light collection system 40 can therefore efficiently capture the fluorescence Y output over the wide radiation angle in the form of Lambertian light emission.

The fluorescence Y is substantially parallelized by the light collection system 40, and the chief ray of the fluorescence Y travels along the center axis 40C and enters the first optical system 30. The fluorescence Y having entered the first optical system 30 is reflected by a second optical element 32, which will be described later, travels along the illumination optical axis AX, and enters the optical path adjustment system 60.

The other part of the blue light K1, which is the part reflected by the light separation film 52, is output from the wavelength converter 50 toward the light collection system 40 along with the fluorescence Y. The other part of the blue light K1 is blue-component-containing light that forms, along with the yellow fluorescence Y, the white illumination light WL.

In the following description, the other part of the blue light K1, which is the part reflected by the light separation film 52, is referred to in some cases as the blue reflected light RB. That is, the blue reflected light RB corresponds to an example of “another part of the first light” in the present disclosure.

As described above, in the light source apparatus 2 according to the present embodiment, in which the optical path of the fluorescence Y output from the wavelength converter 50 and entering the first optical system 30 coincides with the optical path of the blue reflected light RB reflected by the light separation film 52 and entering the first optical system 30, the light collection system 40 can also be used as an optical system that picks up the fluorescence Y and the blue reflected light RB. According to the configuration described above, in which a portion of the optical path of the light collection system 40 is common to the fluorescence and the blue component for illumination light, the size of the apparatus configuration can be reduced as compared with a configuration in which multiple light collection systems are required, that is, the optical path of the fluorescence and the optical path of the blue component for illumination light are separately provided.

As described above, the blue light K1 obliquely enters the wavelength converter 50 and is specularly reflected by the light separation film 52. The blue reflected light RB, which is the reflected component of the blue light K1, therefore travels along an optical path different from the optical path of the blue light K1 directed to the wavelength converter 50, and enters the light collection system 40. The blue reflected light RB is parallelized by the light collection system 40, travels along the optical axis ax2, and enters the first optical system 30.

The first optical system 30 includes a first optical element 31 and the second optical element 32. The first optical element 31 and the second optical element 32 are disposed so as to incline at an angle of 45° with respect to the optical axis ax1 of the blue light K1. The first optical element 31 is disposed at a position shifted from the second optical element 32 toward the light source 20. The second optical element 32 is disposed at a position shifted from the first optical element 31 toward the wavelength converter 50.

The first optical element 31 transmits the blue light K1 output from the light source 20. The first optical element 31 includes a light transmissive substrate 310, a blue reflection film 311, and a diffusion layer 312. The blue reflection film 311 in the present embodiment corresponds to an example of the “second reflection film” in the present disclosure.

The light transmissive substrate 310 is configured, for example, with a light transmissive substrate made, for example, of glass or plastic, and has a first surface 310a, on which the blue light K1 output from the light source 20 is incident, and a second surface 310b opposite the first surface 310a.

The blue reflection film 311 is disposed at a portion of the first surface 310a of the light transmissive substrate 310. The blue reflection film 311 is configured with a dichroic mirror that reflects at least the blue light K1 having the blue wavelength band.

The diffusion layer 312 is disposed over the entire region of the second surface 310b of the light transmissive substrate 310. The diffusion layer 312 is a transmissive diffusion layer that diffusively transmits the blue light K1.

In the present embodiment, the blue light K1 output from the light source 20 and the blue reflected light RB enter different regions of the first optical element 31.

The first surface 310a of the light transmissive substrate 310 has a first region 31A and a second region 31B. The first region 31A is a region where the blue reflection film 311 is disposed. The second region 31B is a region that transmits the blue light K1 incident from the light source 20.

The second surface 310b of the light transmissive substrate 310 has a third region 31C and a fourth region 31D. The third region 31C is a region where the diffusion layer 312 is disposed and which faces the second region 31B of the first surface 310a, and is also a region that transmits the blue light K1 output from the light source 20. The fourth region 31D is a region where the diffusion layer 312 is disposed and which faces the first region 31A of the first surface 310a, and is also a region through which the blue reflected light RB passes.

In the present embodiment, the light source 20 and the first optical element 31 are so aligned with each other that the blue light K1 output from the light source 20 is incident on the second region 31B of the first surface 310a of the light transmissive substrate 310. The wavelength converter 50 and the first optical element 31 are so aligned with each other that the blue reflected light RB output from the wavelength converter 50 is incident on the fourth region 31D of the second surface 310b of the light transmissive substrate 310.

The blue reflected light RB passes through the diffusion layer 312, is incident on the first region 31A of the first surface 310a from the fourth region 31D of the second surface 310b of the light transmissive substrate 310, and is reflected by the blue reflection film 311 provided in the first region 31A. The chief ray of the blue reflected light RB after being reflected by the blue reflection film 311 travels along the X-axis. The blue reflected light RB reflected by the blue reflection film 311 passes through the first region 31A and the fourth region 31D of the light transmissive substrate 310 and enters the diffusion layer 312. The blue reflected light RB, which is the other part of the blue light K1 separated by the light separation film 52, therefore passes through the diffusion layer 312 twice in the first optical element 31. That is, the blue reflected light RB, which is the other part of the first light output from the light source 20, passes through the diffusion layer 312 three times and is diffused.

The blue light K1 in the present embodiment is laser light, and is therefore highly coherent and tends to cause interference fringes and speckle noise to be visually recognized. In contrast, the blue light K1 is caused to pass through the diffusion layer 312 three times and is therefore sufficiently diffused in the present embodiment, so that the produced interference fringes and speckle noise can be made hardly noticeable even when the blue light K1, which is laser light, is used.

In the light source apparatus 2 according to the present embodiment, the fluorescence Y and the blue reflected light RB output from the wavelength converter 50 are parallelized by the light collection system 40 and then enter the second optical element 32. The second optical element 32 includes a dichroic film 32a, which transmits the blue light K1 having the first wavelength band and reflects the fluorescence Y. That is, the second optical element 32 transmits the blue light K1 output from the light source 20 and the blue reflected light RB output from the wavelength converter 50. Therefore, the fluorescence Y is reflected by the second optical element 32 toward the +X side and travels along the illumination optical axis AX. The dichroic film 32a in the present embodiment corresponds to an example of the “third reflection film” in the present disclosure.

In the light source apparatus 2 according to the present embodiment, the blue reflected light RB and the fluorescence Y having traveled via the first optical system 30 are output in the same direction (X-axis direction). That is, the direction in which the blue reflected light RB is output from the first optical element 31 extends along the direction in which the fluorescence Y is output from the second optical element 32. According to the configuration described above, since the blue reflected light RB and the fluorescence Y are output in the same direction, the white illumination light WL containing the blue reflected light RB and the fluorescence Y can be efficiently generated.

The light source apparatus 2 according to the present embodiment further includes the optical path adjustment 60, which the illumination light WL containing the blue reflected light RB and the fluorescence Y output from the first optical system 30 enters.

The optical path adjustment system 60 includes a first mirror 61 and a second mirror 62.

The first mirror 61 is disposed so as to incline at an angle of 45° with respect to an optical axis ax3 of the blue reflected light RB output from the first optical element 31. The second mirror 62 is disposed on the +Y side of the first mirror 61 and on the +X side of the first optical system 30 so as to face the first mirror 61. The second mirror 62 is disposed next to the first optical system 30 on the illumination optical axis AX.

The first mirror 61 is configured with a mirror that reflects the blue reflected light RB. The first mirror 61 reflects the blue reflected light RB toward the +Y side. The blue reflected light RB reflected by the first mirror 61 is incident on the second mirror 62. The second mirror 62 is configured with a dichroic mirror having an optical characteristic of reflecting the blue reflected light RB, which is light first wavelength band, and transmitting the fluorescence Y, which is light having the second wavelength band.

The configuration in which the blue reflected light RB is reflected by the first mirror 61 and the second mirror 62 causes the optical path of the blue reflected light RB to be shifted toward the −Y side and approaches the illumination optical axis AX after passing through the optical path adjustment system 60. Since the fluorescence Y passes through the second mirror 62, the optical path of the fluorescence Y does not change before and after passing through the optical path adjustment system 60.

The optical path adjustment system 60 brings the optical path of the blue reflected light RB reflected by the blue reflection film 311 of the first optical element 31 close to the optical path of the fluorescence Y (illumination optical axis AX) reflected by the dichroic film 32a of the second optical element 32. The optical path adjustment system 60 can therefore achieve a state in which the optical paths of the blue reflected light RB and the fluorescence Y at least partially overlap with each other. The configuration described above, in which the optical paths of the blue reflected light RB and the fluorescence Y overlap with each other, can suppress color unevenness of the illumination light WL.

As described above, in the light source apparatus 2 according to the present embodiment, the optical path adjustment system 60 guides the blue reflected light RB to the optical path of the fluorescence Y to generate the white illumination light WL, and causes the white illumination light WL to enter the uniform illumination system 70. The uniform illumination system 70 is disposed along the illumination optical axis AX of the light source apparatus 2. The uniform illumination system 70 includes a first lens array 71, a second lens array 72, a polarization converter 73, and a superimposing lens 74.

The first lens array 71 includes multiple first lenses 71a, which divide the illumination light WL incident from the optical path adjustment system 60 into multiple sub-luminous fluxes. The multiple first lenses 71a are arranged in a matrix in a plane perpendicular to the illumination optical axis AX.

The second lens array 72 includes multiple second lenses 72a corresponding to the multiple first lenses 71a of the first lens array 71. The multiple second lenses 72a are arranged in a matrix in a plane perpendicular to the illumination optical axis AX.

The second lens array 72 along with the superimposing lens 74 brings images of the first lenses 71a of the first lens array 71 into focus in the vicinity of an image formation region of each of the light modulators 4R, 4G, and 4B.

The polarization converter 73 converts the light output from the second lens array 72 into one kind of linearly polarized light. The polarization converter 73 includes, for example, polarization separation films and retardation films (none of which is shown).

The superimposing lens 74 collects the sub-luminous fluxes output from the polarization converter 73 and superimposes the collected sub-luminous fluxes on one another in the vicinity of the image formation region of each of the light modulators 4R, 4G, and 4B. Note that the uniform illumination system 70 may include a rod lens that homogenizes the illuminance distribution of light.

As described above, the light source apparatus 2 according to the present embodiment includes the light source 20, which outputs the blue light K1 having the blue wavelength band, the first optical system 30, which the blue light K1 output from the light source 20 enters, the light collection system 40, which the blue light K1 having passed through the first optical system 30 enters, and the wavelength converter 50, which converts part of the blue light K1 into the fluorescence Y having a yellow wavelength band different from the blue wavelength band. The wavelength converter 50 includes the wavelength conversion layer 51 having the light exiting surface 51a, on which the blue light K1 is incident and through which the fluorescence Y exits, and the light separation film 52, which is provided at the light exiting surface 51a and separates the blue light K1 into part thereof and the other part thereof. The first optical system 30 includes the first optical element 31 and the second optical element 32. The first optical element 31 includes the blue reflection film 311, which reflects the blue reflected light RB, which is the other part of the blue light K1, and the diffusion layer 312, which diffusively transmits the blue light K1. The second optical element 32 includes the dichroic film 32a, which transmits the blue light K1 and reflects the fluorescence Y.

In the light source apparatus 2 according to the present embodiment, the light separation film 52 provided at the light exiting surface 51a of the wavelength converter 50 can separate the blue light K1 output from the light source 20 into the excitation light and the blue component of the illumination light. The optical path of the fluorescence Y output from the wavelength converter 50 and the optical path of the blue component reflected by the light separation film 52 thus partially coincide with each other, so that the size of the apparatus configuration can be reduced.

Furthermore, in the light source apparatus 2 according to the present embodiment, the blue reflected light RB passes through the diffusion layer 312 three times and is therefore sufficiently diffused. Therefore, even when laser light, which is highly coherent, is used as the blue light K1, the light source apparatus 2 according to the present embodiment can make interference fringes and speckle noise produced in the illumination light WL hardly noticeable. The light source apparatus 2 according to the present embodiment can therefore generate the illumination light WL that prevents interference fringes or speckle noise from being produced.

Note that the uniform illumination system 70 in the light source apparatus 2 according to the present embodiment is not an essential element, and the uniform illumination system 70 may be omitted depending on the illuminance distribution or the like required for the illumination light WL.

The projector 1 according to the present embodiment includes the light source apparatus 2 described above and can therefore be a compact projector that displays a high-quality color image in which interference fringes and speckle noise are suppressed.

### Modification

A modification of the light source apparatus will subsequently be described with reference to the drawings. The present modification is the same as the first embodiment in terms of the basic configuration, but differs therefrom in terms of the configuration of an optical path adjustment system. The configurations of the optical path adjustment system will therefore be primarily described below, and the elements common to those in the drawings used in the embodiment described above have the same reference characters and will not be described.

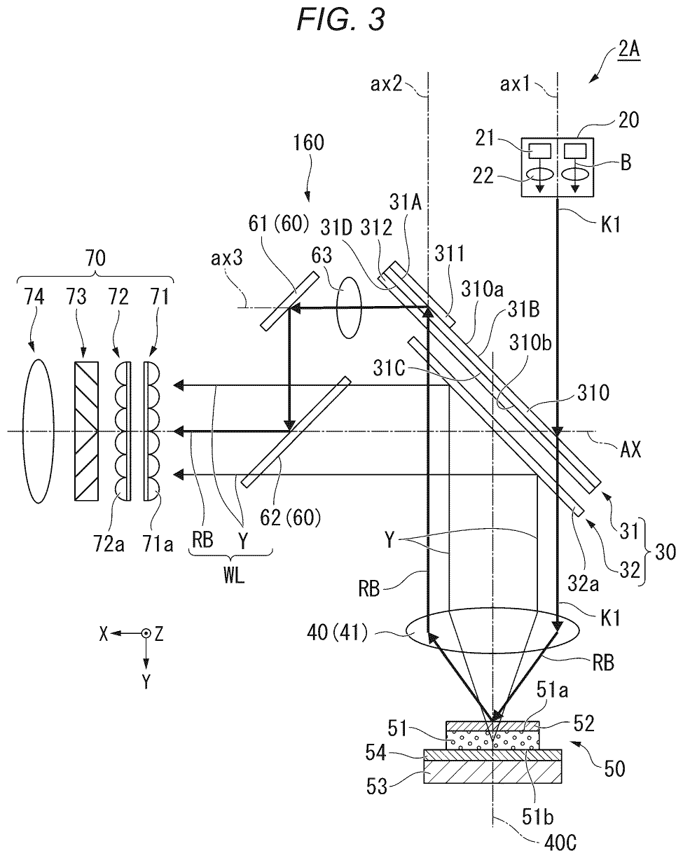

FIG. 3 is a schematic view showing the configuration of a light source apparatus 2A according to the modification.

The light source apparatus 2A according to the present modification includes the light source 20, the first optical system 30, the light collection system 40, the wavelength converter 50, an optical path adjustment system 160, and the uniform illumination system 70, as shown in FIG. 3.

The optical path adjustment system 160 in the present modification further includes a light collection lens 63 in addition to the first mirror 61 and the second mirror 62. The light collection lens 63 is provided in the optical path of the blue reflected light RB and collects the blue reflected light RB. In the present modification, the light collection lens 63 is a convex lens provided so as to face the first optical element 31. The light collection lens 63 collects the blue reflected light RB output from the first optical element 31 that has been diffused and has therefore spread to reduce the luminous flux width of the blue reflected light RB.

In the light source apparatus 2A according to the present modification, which includes the optical path adjustment system 160 including the light collection lens 63, the amount of spread of the blue reflected light RB is suppressed, so that the blue reflected light RB can be efficiently incident on the first mirror 61 and the second mirror 62. Furthermore, the suppression of the luminous flux width of the blue reflected light RB allows suppression of an increase in size of the first mirror 61 and the second mirror 62.

The light source apparatus 2A according to the present modification can therefore be a light source apparatus capable of efficiently using the blue reflected light RB as the illumination light WL and therefore having high light use efficiency.

### Second Embodiment

A light source apparatus according to a second embodiment of the present disclosure will subsequently be described. The second embodiment is the same as the first embodiment in terms of the basic configuration, but differs therefrom in terms of the configurations of the first optical system and elements therearound. The configurations of the first optical system and elements therearound will therefore be primarily described below, and the elements common to those in the drawings used in the embodiment described above have the same reference characters and will not be described.

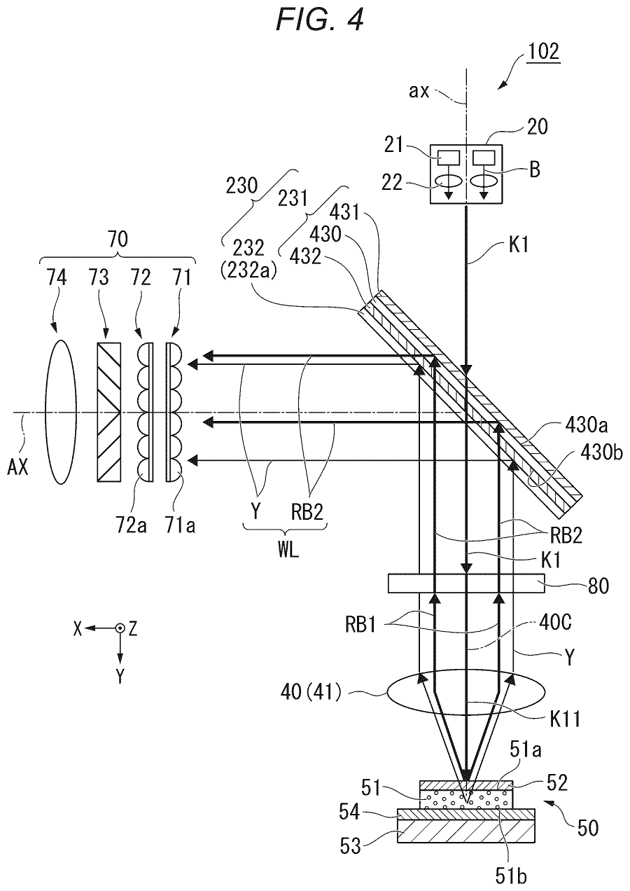

FIG. 4 is a schematic view showing the configuration of a light source apparatus 102 according to the second embodiment.

The light source apparatus 102 according to the present embodiment includes the light source 20, a first optical system 230, the light collection system 40, the wavelength converter 50, the uniform illumination system 70, and a retardation film 80, as shown in FIG. 4.

In the light source apparatus 102 according to the present embodiment, the light source 20, the first optical system 230, the retardation film 80, the light collection system 40, and the wavelength converter 50 are arranged along the optical axis ax1 of the light source 20. The first optical system 230 and the uniform illumination system 70 are disposed in the X-axis direction along the illumination optical axis AX.

The first optical system 230 includes a first optical element 231 and a second optical element 232. In the present embodiment, the first optical element 231 and the second optical element 232 are bonded to each other via, for example, an optical adhesive. The first optical element 231 and the second optical element 232 are therefore readily aligned with each other.

The first optical element 231 transmits the blue light K1 output from the light source 20. The first optical element 231 includes a light transmissive substrate 430, a polarization separation film 431, and a diffusion layer 432. The polarization separation film 431 in the present embodiment corresponds to an example of the “second reflection film” in the present disclosure.

The light transmissive substrate 430 is configured, for example, with a light transmissive substrate made, for example, of glass or plastic, and has a first surface 430a, on which the blue light K1 output from the light source 20 is incident, and a second surface 430b opposite the first surface 430a.

The polarization separation film 431 is disposed at the first surface 430a of the light transmissive substrate 430. The polarization separation film 431 has a polarization separation function of separating the blue light K1 into a P-polarized component (first polarized component) and an S-polarized component (second polarized component) with respect to the polarization separation film 431. Specifically, the polarization separation film 431 transmits the P-polarized component of the blue light K1 and reflects the S-polarized component of the blue light K1 and the S-polarized component of the blue reflected light RB, which will be described later.

In the present embodiment, the direction in which the blue light K1 output from the light source 20 is polarized coincides with the direction in which the P-polarized component passing through the polarization separation film 431 is polarized.

Therefore, the blue light K1 output from the light source 20 passes through the polarization separation film 431, and passes through the light transmissive substrate 430 and the diffusion layer 432. That is, the blue light K1 passes through the first optical element 231.

The blue light K1 having passed through the first optical element 231 enters the second optical element 232 with the blue light K1 being diffused when passing through the diffusion layer 432. The second optical element 232 includes a dichroic film 232a, which transmits the blue light K1 having the blue wavelength band irrespective of the polarization direction thereof, and reflects the fluorescence Y having the yellow wavelength band irrespective of the polarization direction thereof. The second optical element 232 is bonded to the diffusion layer 432 of the first optical element 231.

The blue light K1 thus output from the light source 20 passes through the first optical system 230 including the first optical element 231 and the second optical element 232. The blue light K1 having passed through the first optical system 230 enters the retardation film 80.

The retardation film 80 is configured with a quarter-wave plate (λ/4 plate) disposed in the optical path between the first optical system 230 and the wavelength converter 50. The blue light K1, which is the P-polarized component output from the light source 20, is therefore converted, for example, into blue light K11, which is right-handed circularly polarized light, when passing through the retardation film 80, and then enters the light collection system 40.

The blue light K11 is collected by the light collection system 40 and enters the wavelength converter 50. Part of the blue light K1 is converted into the fluorescence Y by the wavelength converter 50, and the other part of the blue light K1 is reflected as blue reflected light RB1.

In the present embodiment, the optical axis ax1 of the blue light K11 entering the light collection system 40 coincides with the center axis 40C of the light collection system 40. Therefore, in the present embodiment, in the wavelength converter 50, the chief ray of the blue reflected light RB1 reflected by the light separation film 52 travels along the same path as the chief ray of the blue light K1 and returns to the light source 20.

As described above, since the blue light K11 before being reflected by the light separation film 52 is right-handed circularly polarized light, the blue light K11 becomes left-handed circularly polarized light after being reflected by the light separation film 52. That is, the blue light K11 is output from the wavelength converter 50 as the blue reflected light RB1, which is left-handed circularly polarized light, is substantially parallelized by the light collection system 40, and enters the retardation film 80. The blue reflected light RB1 is converted into blue reflected light RB2 configured with the S-polarized component when passing through the retardation film 80, and the chief ray of the blue reflected light RB2 travels along the same path as the chief ray of the fluorescence Y and returns to the light source 20.

As described above, in the present embodiment, the blue reflected light RB1 having passed through the retardation film 80 becomes the blue reflected light RB2, which is light configured with the S-polarized component different from the P-polarized component output from the light source 20.

The blue reflected light RB2 passes through the second optical element 232 and enters the first optical element 231. The blue reflected light RB2 passes through the diffusion layer 432 and the light transmissive substrate 430 of the first optical element 231 and enters the polarization separation film 431. The blue reflected light RB2, which is the S-polarized component as described above is reflected by the polarization separation film 431, passes through the light transmissive substrate 430 and the diffusion layer 432 again, exits out of the first optical element 231, and passes through the second optical element 232.

In the present embodiment, the blue reflected light RB2 passes through the diffusion layer 432 three times and is therefore sufficiently diffused, and is output as the illumination light WL. Therefore, even when laser light, which is highly coherent, is used as the blue light K1, the present embodiment can also make interference fringes and speckle noise produced in the illumination light WL hardly noticeable. The light source apparatus 102 according to the present embodiment can therefore also generate the illumination light WL that prevents interference fringes or speckle noise from being produced.

The fluorescence Y output from the wavelength converter 50 is substantially parallelized by the light collection system 40 and enters the retardation film 80. The fluorescence Y, which is non-polarized light, passes through the retardation film 80 without the polarization state thereof being changed, enters the first optical system 230, and is reflected by the second optical element 232 toward the +X side.

The light source apparatus 102 according to the present embodiment can also output the illumination light WL containing the blue reflected light RB2 and the fluorescence Y from the first optical system 230 in the X-axis direction. In the present embodiment, since the chief ray of the blue reflected light RB2 and the chief ray of the fluorescence Y coincide with each other, the width where the blue reflected light RB2 and the fluorescence Y overlap with each other can be increased without using the optical path adjustment system 60. The light source apparatus 102 according to the present embodiment can therefore output the illumination light WL with color unevenness thereof reduced and the size of the apparatus configuration reduced at the same time.

Furthermore, in the light source apparatus 102 according to the present embodiment, the polarization direction of the blue light K1 output from the light source 20 and entering the first optical element 231 differs from the polarization direction of the blue reflected light RB2 output from the wavelength converter 50 and entering the first optical element 231. The polarization separation film 431 of the first optical element 231 therefore does not need to be so configured that the region through which the blue light K1 passes and the region through which the blue reflected light RB2 passes differ from each other. The light source apparatus 102 according to the present embodiment, in which it is not necessary to shift the optical path of the blue light K1 and the optical path of the blue reflected light RB2 in the X-axis direction, in which the illumination light WL is extracted, therefore has no restriction on the layout of the parts of the light source apparatus 102, so that the degree of freedom in design is increased, and the size of the apparatus configuration can be reduced.

Now, the greater the luminous flux width of the blue reflected light RB2, the smaller the difference in the luminous flux width between the blue reflected light RB2 and the fluorescence Y, so that the color unevenness of the illumination light WL can be reduced. To increase the luminous flux width of the blue reflected light RB2, it is desirable to diffuse the blue reflected light RB2 in an optical path outside the diffusion layer 432. A conceivable position where the blue reflected light RB2 is scattered is, for example, the position of the wavelength converter 50.

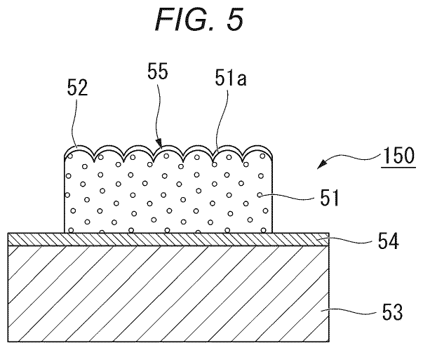

A configuration in which the blue reflected light RB2 is scattered in the wavelength converter 50 will be described below. FIG. 5 shows the configuration of a modification of the wavelength converter.

A wavelength converter 150 according to the present modification includes the wavelength conversion layer 51, the light separation film 52, the substrate 53, and the reflection member 54, as shown in FIG. 5. In the wavelength converter 150 according to the present modification, the light exiting surface 51a of the wavelength conversion layer 51 has a scattering structure 55, which scatters incident light. The scattering structure 55 is configured, for example, with irregularities formed by roughening the surface of the light exiting surface 51a in a sandblasting process or the like. The light separation film 52 is provided at the light exiting surface 51a so as to cover the scattering structure 55.

According to the wavelength converter 150 having the configuration shown in FIG. 5, when the other part of the blue light K1 incident from the light source 20 is reflected as the blue reflected light RB1, the blue reflected light RB1 can be diffusively reflected by the scattering structure 55.

According to the configuration described above, the blue reflected light RB2 contained in the illumination light WL can be diffused four times, including the diffusion performed by the scattering structure 55 of the wavelength converter 150. The blue reflected light RB2 can therefore be sufficiently diffused, so that interference fringes and speckle noise produced in the illumination light WL can be made hardly noticeable, and the color unevenness of the illumination light WL can be further reduced.

Furthermore, the light source apparatus 102 according to the present embodiment has been presented with reference to the case where the optical axis ax1 of the blue light K11 and the center axis 40C of the light collection system 40 coincide with each other, but the optical axis ax1 of the blue light K11 and the center axis 40C of the light collection system 40 may be shifted from each other as in the first embodiment. In this case, the optical path of the blue reflected light RB2 may be brought close to the optical path of the fluorescence Y by combining the optical path adjustment system 60 with the light source apparatus 102.

Note that the technical scope of the present disclosure is not limited to the embodiments described above, and various modifications can be made thereto to the extent that the modifications do not depart from the intent of the present disclosure.

In addition, the specific description of the shapes, the quantity, the arrangements, the materials, and other factors of the elements of the light source apparatus and the projector are not limited to those in the embodiments described above, and can be changed as appropriate.

The present disclosure is summarized below as additional remarks.

### Additional Remark 1

The light source apparatus including:
a light source configured to output first light having a first wavelength band;
a first optical system that the first light output from the light source enters;
a light collection system that the first light passing through the first optical system enters; and
a wavelength converter configured to convert part of the first light into second light having a second wavelength band different from the first wavelength band,
wherein the wavelength converter includes a wavelength conversion layer having a light exiting surface on which the first light is incident and through which the second light exits, and a first reflection film provided at the light exiting surface and configured to separate the first light into the part and another part,
the first optical system includes a first optical element and a second optical element,
the first optical element includes a second reflection film configured to reflect the other part of the first light, and a diffusion layer configured to diffusively transmit the first light, and
the second optical element includes a third reflection film configured to transmit the first light and reflect the second light.

According to the light source apparatus having the configuration described above, the first reflection film provided at the light exiting surface of the wavelength converter can separate the first light output from the light source into part of the first light for wavelength conversion and the other part of the first light for illumination. The optical path of the second light output from the wavelength converter and the optical path of the illumination light reflected by the first reflection film thus coincide with each other, so that the size of the apparatus configuration can be reduced.

Furthermore, the other part of the first light for illumination passes through the diffusion layer three times and is therefore sufficiently diffused. Therefore, for example, even when laser light, which is highly coherent, is used as the first light, interference fringes and speckle noise produced in the illumination light can be made hardly noticeable. A light source apparatus that generates illumination light that prevents interference fringes or speckle noise from being produced can therefore be provided.

### Additional Remark 2

The light source apparatus according to Additional Remark 1, wherein
the first optical element further includes a light transmissive substrate having a first surface on which the first light output from the light source is incident, and a second surface opposite the first surface,
the second reflection film is disposed at the first surface of the light transmissive substrate, and
the diffusion layer is disposed at the second surface of the light transmissive substrate.

According to the configuration described above, the configuration of the first optical element can be readily provided by providing the second reflection film and the diffusion layer at both surfaces of the light transmissive substrate.

### Additional Remark 3

The light source apparatus according to Additional Remark 2, wherein
the first light output from the light source and the other part of the first light enter different regions of the first optical element,
the first surface of the light transmissive substrate has a first region in which the second reflection film is disposed, and a second region configured to transmit the first light incident from the light source, and
the second surface of the light transmissive substrate has a third region in which the diffusion layer is disposed and which faces the second region of the first surface, and a fourth region in which the diffusion layer is disposed, which faces the first region of the first surface, and through which the other part of the first light passes.

According to the configuration described above, the other part of the first light that is reflected by the second reflection film passes through the first region and the fourth region of the light transmissive substrate and enters the diffusion layer. Since the other part of the first light passes through the diffusion layer 312 twice in the first optical element, the other part of the first light output from the light source passes through the diffusion layer three times. Therefore, even when laser light is used as the first light, the produced interference fringes and speckle noise can be made hardly noticeable.

### Additional Remark 4

The light source apparatus according to any one of Additional Remarks 1 to 3, wherein
an optical path of the second light reflected by the third reflection film of the second optical element at least partially overlaps with an optical path of the other part of the first light that is reflected by the second reflection film of the first optical element.

The configuration described above allows the optical path of the other part of the first light to at least partially overlaps with the optical path of the second light, so that color unevenness of the illumination light can be suppressed.

### Additional Remark 5

The light source apparatus according to Additional Remark 4, further including
an optical path adjustment system configured to bring the optical path of the other part of the first light that is reflected by the second reflection film close to the optical path of the second light reflected by the third reflection film.

According to the configuration described above, the optical path adjustment system can readily achieve the state in which the optical path of the other part of the first light at least partially overlaps with the optical path of the second light.

### Additional Remark 6

The light source apparatus according to Additional Remark 5, wherein
the optical path adjustment system includes a light collection lens provided in the optical path of the other part of the first light and configured to collect the other part of the first light.

The configuration described above, which includes the optical path adjustment system including the light collection lens, can suppress the spread of the other part of the first light to efficiently cause the other part of the first light to enter a downstream optical system. A light source apparatus capable of efficiently using the other part of the first light as the illumination light and therefore having high light use efficiency can be provided.

### Additional Remark 7

The light source apparatus according to any one of Additional Remarks 1 to 6, wherein
the light collection system includes a lens having positive power, and
an optical axis of the first light that enters the light collection system is shifted from a center axis of the light collection system.

According to the configuration described above, the first light is obliquely incident on a central portion of the wavelength converter. The other part of the first light is therefore reflected by the first reflection film, travels along an optical path different from the optical path of the first light, and can enter the light collection system.

### Additional Remark 8

The light source apparatus according to any one of Additional Remarks 1 to 6,
further including a retardation film disposed between the first optical system and the wavelength converter,
wherein the first light output from the light source is light configured with a first polarized component,
the other part of the first light that passes through the retardation film is light configured with a second polarized component different from the first polarized component, and
the second reflection film is configured to transmit the light configured with the first polarized component and reflect the light configured with the second polarized component.

According to the configuration described above, since the second reflection film can separate the first light based on the polarized components thereof, it is not necessary to shift the optical path of the first light output from the light source and the optical path of the other part of the first light from each other. Therefore, there is no restriction on the layout of the parts of the light source apparatus, the degree of freedom in design is increased, and the apparatus configuration can be reduced in size.

### Additional Remark 9

The light source apparatus according to Additional Remark 8, wherein
the light exiting surface of the wavelength conversion layer has a scattering structure configured to scatter incident light.

According to the configuration described above, since the other part of the first light contained in the illumination light is diffused four times including the diffusion performed by the scattering structure of the wavelength converter, the other part of the first light can be sufficiently diffused. Therefore, interference fringes and speckle noise produced in the illumination light can be made hardly noticeable, and the color unevenness of the illumination light can be further reduced.

### Additional Remark 10

The light source apparatus according to Additional Remark 8 or 9, wherein
the light collection system includes a lens having positive power, and
an optical axis of the first light that enters the light collection system coincides with a center axis of the light collection system.

According to the configuration described above, the chief ray of the other part of the first light that is reflected by the second reflection film travels along the same path as the chief ray of the first light incident from the light source and returns to the light source. Furthermore, the chief ray of the second light output from the wavelength converter travels along the same path as the chief ray of the other part of the first light and returns to the light source. The width where the other part of the first light and the second light overlap with each other thus increases, so that illumination light with reduced color unevenness can be output while the size of the configuration of the light source apparatus is reduced.

### Additional Remark 11

The light source apparatus according to any one of Additional Remarks 1 to 10, wherein
the wavelength converter further includes a substrate configured to support a surface of the wavelength conversion layer that is a surface opposite the light exiting surface, and a reflection member provided between the substrate and the wavelength conversion layer and configured to reflect the second light.

According to the configuration described above, the reflection member can reflect the second light toward the wavelength conversion layer. The second light can therefore be efficiently extracted from the wavelength converter.

### Additional Remark 12

A projector including:
the light source apparatus according to any one of Additional Remarks 1 to 11;
a light modulator configured to modulate light incident from the light source apparatus; and
a projection optical apparatus configured to project the light modulated by the light modulator.

The projector having the configuration described above, which includes the light source apparatus described above, can provide a compact projector that displays a high-quality color image in which interference fringes and speckle noise are suppressed.

What is claimed is:

1. A light source apparatus comprising:
a light source configured to output first light having a first wavelength band;
a first optical system that the first light output from the light source enters;
a light collection system that the first light passing through the first optical system enters; and
a wavelength converter configured to convert part of the first light into second light having a second wavelength band different from the first wavelength band,
wherein the wavelength converter includes a wavelength conversion layer having a light exiting surface on which the first light is incident and through which the second light exits, and a first reflection film provided at the light exiting surface and configured to separate the first light into the part of the first light and the other part of the first light,
the first optical system includes a first optical element and a second optical element,
the first optical element includes a second reflection film configured to reflect the other part of the first light, and a diffusion layer configured to diffusively transmit the first light, and
the second optical element includes a third reflection film configured to transmit the first light and reflect the second light.

2. The light source apparatus according to claim 1, wherein
the first optical element further includes a light transmissive substrate having a first surface on which the first light output from the light source is incident, and a second surface opposite the first surface,
the second reflection film is disposed at the first surface of the light transmissive substrate, and
the diffusion layer is disposed at the second surface of the light transmissive substrate.

3. The light source apparatus according to claim 2, wherein
the first light output from the light source and the other part of the first light enter different regions of the first optical element,
the first surface of the light transmissive substrate has a first region in which the second reflection film is disposed, and a second region configured to transmit the first light incident from the light source, and
the second surface of the light transmissive substrate has a third region in which the diffusion layer is disposed and which faces the second region of the first surface, and a fourth region in which the diffusion layer is disposed, which faces the first region of the first surface, and through which the other part of the first light passes.

4. The light source apparatus according to claim 1, wherein
an optical path of the second light reflected by the third reflection film of the second optical element at least partially overlaps with an optical path of the other part of the first light that is reflected by the second reflection film of the first optical element.

5. The light source apparatus according to claim 4, further comprising
an optical path adjustment system configured to bring the optical path of the other part of the first light that is reflected by the second reflection film close to the optical path of the second light reflected by the third reflection film.

6. The light source apparatus according to claim 5, wherein
the optical path adjustment system includes a light collection lens provided in the optical path of the other part of the first light and configured to collect the other part of the first light.

7. The light source apparatus according to claim 1, wherein
the light collection system includes a lens having positive power, and
an optical axis of the first light that enters the light collection system is shifted from a center axis of the light collection system.

8. The light source apparatus according to claim 1
further comprising a retardation film disposed between the first optical system and the wavelength converter,
wherein the first light output from the light source is light configured with a first polarized component,
the other part of the first light that passes through the retardation film is light configured with a second polarized component different from the first polarized component, and
the second reflection film is configured to transmit the light configured with the first polarized component and reflect the light configured with the second polarized component.

9. The light source apparatus according to claim 7, wherein
the light exiting surface of the wavelength conversion layer has a scattering structure configured to scatter incident light.

10. The light source apparatus according to claim 8, wherein
the light collection system includes a lens having positive power, and
an optical axis of the first light that enters the light collection system coincides with a center axis of the light collection system.

11. The light source apparatus according to claim 1, wherein
the wavelength converter further includes a substrate configured to support a surface of the wavelength conversion layer that is a surface opposite the light exiting surface, and a reflection member provided between the substrate and the wavelength conversion layer and configured to reflect the second light.

12. A projector comprising:
the light source apparatus according to claim 1;
a light modulator configured to modulate light incident from the light source apparatus; and
a projection optical apparatus configured to project the light modulated by the light modulator.
